(19) United States
(12) Patent Application Publication
(10) Pub. No.: US 2011/0148217 A1
(43) Pub. Date: Jun. 23, 2011

(54) POWER SUPPLY REGULATING DEVICE

(75) Inventor: HAI-ZHOU WU, Shenzhen (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/833,024

(22) Filed: Jul. 9, 2010

(30) Foreign Application Priority Data
Dec. 17, 2009 (CN) 200910311701.6

(51) Int. Cl. H02J 17/00

(52) U.S. Cl. 307/104

(57) ABSTRACT

A power supply regulating device for supplying electric power to a wireless data card includes an interface, a first voltage regulator connected to the interface, a second voltage regulator connected to the first voltage regulator; and a capacitor connected to both the first voltage regulator and the second voltage regulator. The interface is connected to a power supply and the wireless data card is connected to the second voltage regulator. The first voltage increases the voltage applied on the interface by the power supply, the second voltage regulator regulates the increased voltage to a working voltage provided to the wireless data card and generating a working current in the wireless data card. The capacitor charged by the increased voltage and is capable of discharging to generate a supplementary current provided to the wireless data card.

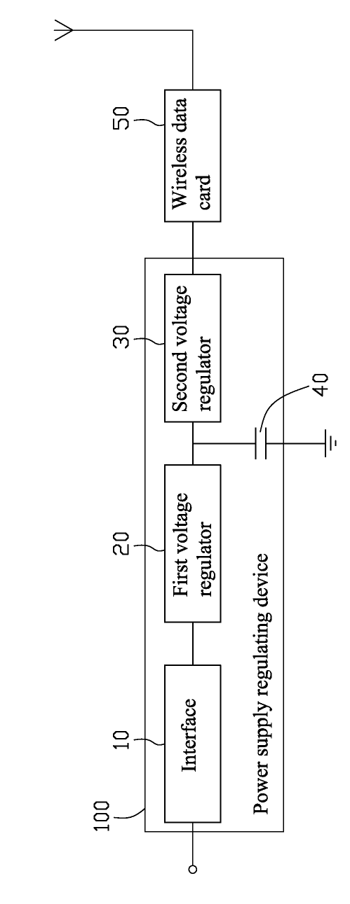

### BACKGROUND

1. Technical Field

The present disclosure relates to power supply regulating devices used in portable electronic devices, and particularly to a power supply regulating device for supplying electric power to wireless data cards.

2. Description of Related Art

Wireless data cards, such as Global System for Mobile communication (GSM) data cards and Wideband Code Division Multiple Access (WCDMA) data cards, are widely used in portable electronic devices, such as mobile phones and laptop computers, for wireless communication. In use, these wireless data cards, which require a high working current, are generally connected to the portable electronic devices via Universal Serial Bus (USB) interfaces or Peripheral Component Interconnect (PCI) interfaces for transmitting data, and the portable electronic devices supplying electric power to the wireless data cards using these interfaces.

When wireless data cards are used, they often need high working currents. Power supply regulating devices are widely used in the portable electronic devices for inputting enough high working currents to the wireless data cards. Conventional power supply regulating devices for supplying electric power to wireless data cards often use capacitors to enhance the working current of the wireless data cards. In this way, the power supply regulating devices can provide currents higher than the maximal currents allowed to pass through the USB/PCI interfaces.

However, in the conventional power supply regulating devices, the capacitances of the capacitors generally need to be very large. For providing a current of about 1.8 A to a wireless data card, the capacitance of a capacitor of a conventional supply regulating device should be about 1.3 mF. Capacitors having such a large capacitance are very expensive.

Therefore, there is room for improvement within the art.

### BRIEF DESCRIPTION OF THE DRAWINGS

Many aspects of the present power supply regulating device can be better understood with reference to the following drawings. The components in the various drawings are not necessarily drawn to scale, the emphasis instead being placed upon clearly illustrating the principles of the present power supply regulating device. Moreover, in the drawings, like reference numerals designate corresponding parts throughout the FIGURES.

The FIGURE is a circuit diagram of a power supply regulating device, according to an exemplary embodiment, providing electric power to a wireless data card.

### DETAILED DESCRIPTION

The FIGURE shows a power supply regulating device 100, according to an exemplary embodiment. The power supply regulating device 100 can be used in a portable electronic device (not shown) capable of being used in wireless communication, such as a mobile phone, a personal digital assistant (PDA), or a laptop computer, to supply electric power to a wireless data card 50 used in the portable electronic device. The wireless data card 50 can be a Global System for Mobile communication (GSM) data card, or a Wideband Code Division Multiple Access (WCDMA) data card.

The power supply regulating device 100 includes a USB/PCI interface 10, a first voltage regulator 20, a second voltage regulator 30, and a capacitor 40. The interface 10 is connected to a conventional circuitry (not shown) of the portable electronic device, such that a conventional power supply, such as a battery of the portable electronic device, can be connected to the interface 10 via the circuitry to provide electric power to the power supply regulating device 100 through the circuitry and the interface 10. The first voltage regulator 20 is a direct current transformer (DC/DC transformer) and is connected to the interface 10. The second voltage regulator 30 can be a DC/DC transformer or a low drop-out regulator (LDO), and is connected to the first voltage regulator 20. The capacitor 40 is connected to both the first voltage regulator 20 and the second voltage regulator 30. In this embodiment, the capacitor 40 has one pole connected between the first voltage regulator 20 and the second voltage regulator 30, and another pole grounded.

In use, the wireless data card 50 is connected to the second voltage regulator 30. The portable electronic device provides electric power to the power supply regulating device 100. An original voltage applied to the interface 10 is about 5V, and a current passing through the interface 10 is about 0.5 A. The original voltage is applied to the first voltage regulator 20 via the interface 10. The first voltage regulator 20 increases the original voltage to a predetermined voltage, such as about 6V, and outputs the increased voltage to the second voltage regulator 30 and the capacitor 40.

The second voltage regulator 30 decreases the increased voltage to about 3.6V, and outputs the decreased voltage to the wireless data card 50. The decreased voltage is used as the working voltage of the wireless data card 50, and generates a working current in the wireless data card 50. Since the working voltage is lower than the original voltage, according to transformer art, the working current is higher than the current passing through the interface 10. In the present disclosure, the working current value is about 5V×0.5 A/3.6V=0.7 A.

The capacitor 40 is charged by the charging voltage. When the wireless data card 50 needs a working current higher than the working current generated by the working voltage, the capacitor 40 is controlled to discharge to the second voltage regulator 30 and the wireless data card 50 by conventional methods (for example, by means of decreasing the voltage on the input connector of the wireless data card 50), thereby generating a supplementary current input to the wireless data card 50 through the second voltage regulator 30 to enhance the working current. In this way, the power supply regulating device 100 can provide a current higher than the maximal current allowed to pass through the interface 10.

In the present power supply regulating device 100, the first voltage regulator 20 increases the original voltage provided by the portable electronic device, and outputs the increased voltage to the capacitor 40 to charge the capacitor 40. Compared with conventional power supply regulating devices, the power supply regulating device 100 can charge the capacitor 40 using a higher voltage, and thus the capacitor 40 can store more electric power during charging and generate a higher current during discharging. If the power supply regulating device 100 and a conventional power supply regulating device are respectively used to provide a same current, the capacitor 40 can be configured to have less capacitance than the capacitor of the conventional power supply regulating device. For example, when the power supply regulating device 100 and a conventional power supply regulating device are respectively used to provide a current that is about 1.8 A to the wireless data card 50, the capacitance of the capacitor 40 in the power supply regulating device 100 should be about 0.4 mF, while the capacitance of the capacitor of the conventional power supply regulating device should be about 1.3 mF. Therefore, the power supply regulating device 100 uses a capacitor of less capacitance which also costs less.

The power supply regulating device 100 can be installed in portable electronic devices connected to wireless data cards, and can also be installed in wireless data cards.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply regulating device for supplying electric power to a wireless data card, comprising:
an interface;
a first voltage regulator connected to the interface;
a second voltage regulator connected to the first voltage regulator; and
a capacitor connected to both the first voltage regulator and the second voltage regulator; wherein the interface is connected to a power supply and the wireless data card is connected to the second voltage regulator; the first voltage increasing the voltage applied on the interface by the power supply, the second voltage regulator regulating the increased voltage to a working voltage provided to the wireless data card and generating a working current in the wireless data card, the capacitor charged by the increased voltage and capable of discharging to generate a supplementary current provided to the wireless data card.

2. The power supply regulating device as claimed in claim 1, wherein the capacitor has one pole connected between the first voltage regulator and the second voltage regulator, and another pole grounded.

3. The power supply regulating device as claimed in claim 1, wherein the capacitor discharges to generate the supplementary current provided to the wireless data card when the wireless data card needs a current higher than the working current generated by the working voltage.

4. The power supply regulating device as claimed in claim 1, wherein the interface is a Universal Serial Bus (USB) interface or a Peripheral Component Interconnect (PCI) interface.

5. The power supply regulating device as claimed in claim 1, wherein the first voltage regulator is a direct current transformer (DC/DC transformer).

6. The power supply regulating device as claimed in claim 1, wherein the second voltage regulator is a DC/DC transformer or a low drop-out regulator (LDO).

7. A power supply regulating device, comprising:
an interface;
a first voltage regulator connected to the interface;
a second voltage regulator connected to the first voltage regulator; and
a capacitor connected to both the first voltage regulator and the second voltage regulator; wherein the interface is connected to a power supply; the first voltage increasing the voltage applied on the interface by the power supply, the second voltage regulator regulating the increased voltage to a working voltage to output and generating a working current to output, the capacitor charged by the increased voltage and capable of discharging to generate a supplementary current to output.

8. The power supply regulating device as claimed in claim 7, wherein the capacitor has one pole connected between the first voltage regulator and the second voltage regulator, and another pole grounded.

9. The power supply regulating device as claimed in claim 7, wherein the capacitor discharges to generate the supplementary current provided to the wireless data card when the wireless data card needs a current higher than the working current generated by the working voltage.

10. The power supply regulating device as claimed in claim 7, wherein the interface is a Universal Serial Bus (USB) interface or a Peripheral Component Interconnect (PCI) interface.

11. The power supply regulating device as claimed in claim 7, wherein the first voltage regulator is a direct current transformer (DC/DC transformer).

12. The power supply regulating device as claimed in claim 7, wherein the second voltage regulator is a DC/DC transformer or a low drop-out regulator (LDO).
